(19) United States
(12) Patent Application Publication
(10) Pub. No.: US 2023/0250611 A1
(43) Pub. Date: Aug. 10, 2023

(54) Box Scraper Assembly

(71) Applicant: Richie Capes, South Haven, MN (US)

(72) Inventor: Richie Capes, South Haven, MN (US)

(21) Appl. No.: 17/668,826

(22) Filed: Feb. 10, 2022

(51) Int. Cl. E02F 3/76

(52) U.S. Cl. CPC E02F 3/7604; E02F 3/7622

(57) ABSTRACT

A box scraper assembly includes a box scraper that is attachable to a tractor for scraping dirt. A plurality of teeth is each movably disposed in the box scraper to dig into the dirt when the box scraper is drawn along the ground. Each of teeth is adjustable between minimum height and a maximum height. An adjustment unit is movably integrated into the box scraper and the adjustment unit is in mechanical communication with each of the teeth. The adjustment unit adjusts each of the teeth between the minimum height and the maximum height. Furthermore, the adjustment unit is in communication with a control on the tractor for actuating the adjustment unit to adjust the teeth between the minimum height and the maximum height.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to scraper devices and more particularly pertains to a new scraper device for scraping dirt during excavation activities. The device includes a box scraper which has a plurality of teeth that are movably integrated into the box scraper.

The device includes an adjustment unit that is movably integrated into the box scraper for adjusting a height of the teeth. The adjustment unit is in communication with a control on the tractor for remotely adjusting the height of the teeth.

### (2) Description of Related Art Including Information Disclosed Under 37 CFR 1.97 and 1.98

The prior art relates to scraper devices including a dirt scraper with a hydraulic piston for adjusting an angle of a blade on the dirt scraper. The prior art discloses a dirt leveling device that includes a plurality of chisels, a leveling blade and a pair of hydraulic actuators for adjusting the height of the chisels and the leveling blade. The prior art discloses a variety of farming implements that each includes a plurality of teeth and a hydraulic actuator for adjusting a height of the teeth. The prior art discloses a box scraper which includes a scraping blade and a hydraulic actuator for adjusting a height of the scraping blade.

### BRIEF SUMMARY OF THE INVENTION

An embodiment of the disclosure meets the needs presented above by generally comprising a box scraper that is attachable to a tractor for scraping dirt. A plurality of teeth is each movably disposed in the box scraper to dig into the dirt when the box scraper is drawn along the ground. Each of teeth is adjustable between minimum height and a maximum height. An adjustment unit is movably integrated into the box scraper and the adjustment unit is in mechanical communication with each of the teeth. The adjustment unit adjusts each of the teeth between the minimum height and the maximum height. Furthermore, the adjustment unit is in communication with a control on the tractor for actuating the adjustment unit to adjust the teeth between the minimum height and the maximum height.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a left side view of a box scraper assembly according to an embodiment of the disclosure.

FIG. 2 is a front view of an embodiment of the disclosure.

FIG. 3 is a top view of an embodiment of the disclosure.

### DETAILED DESCRIPTION OF THE INVENTION

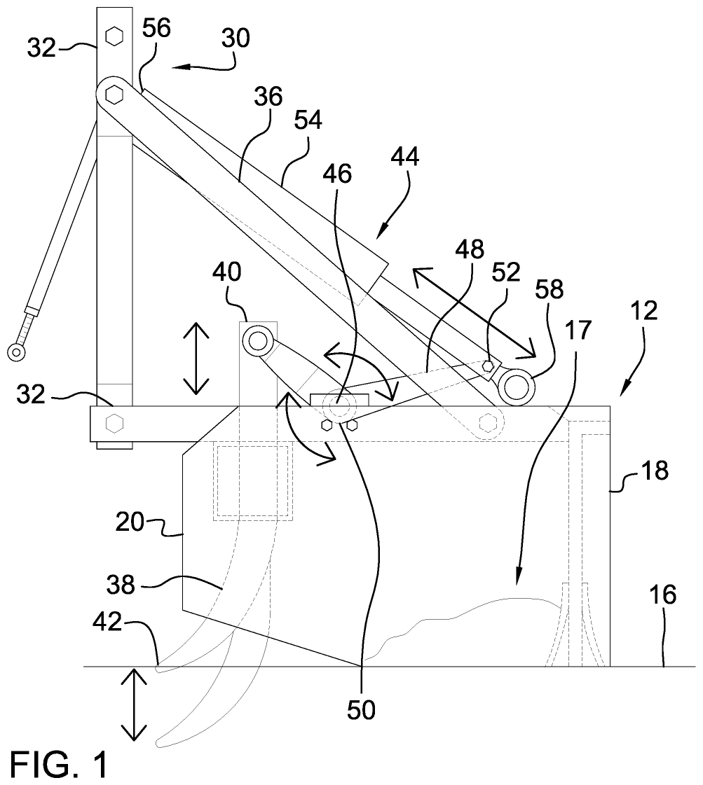

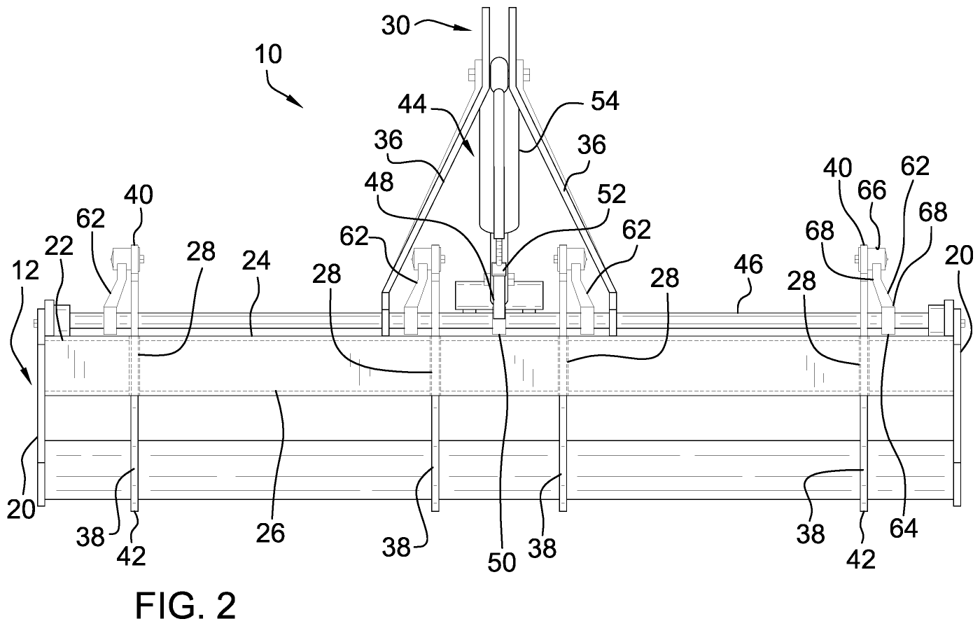

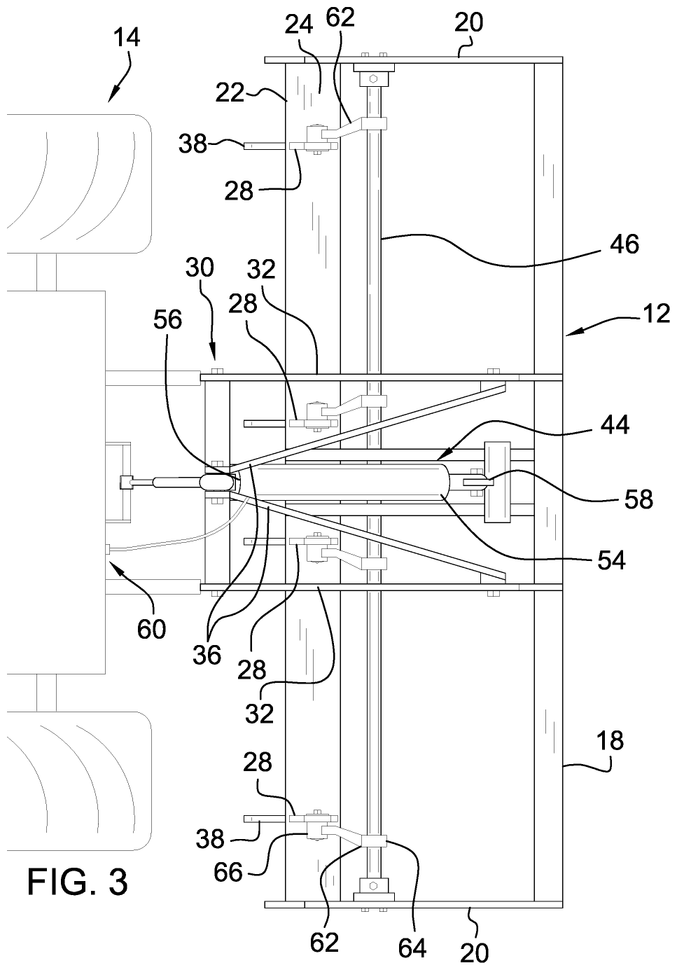

With reference now to the drawings, and in particular to FIGS. 1 through 3 thereof, a new scraper device embodying the principles and concepts of an embodiment of the disclosure and generally designated by the reference numeral 10 will be described.

As best illustrated in FIGS. 1 through 3, the box scraper assembly 10 generally comprises a box scraper 12 that is attachable to a tractor 14 such that the box scraper 12 can be drawn across the ground 16 for scraping dirt 17. The box scraper 12 has a rear wall 18 extending between a pair of lateral walls 20 and the box scraper 12 includes a primary member 22 extending between the pair of lateral walls 20. The primary member 22 is spaced from the rear wall 18 and the primary member 22 has a top side 24 and a bottom side 26. Furthermore, the primary member 22 has a plurality of slots 28 each extending through the top side 24 and the bottom side 26. The slots 28 are spaced apart from each other and are distributed along a full length of the primary member 22.

The box scraper 12 includes a mounting bracket 30 which has a vertical member 32 extending upwardly from the box scraper 12 and a plurality of horizontal members 34 is perpendicularly oriented with the vertical member 32. Additionally, the mounting bracket 30 includes a pair of angled members 36 each angling between the vertical member 32 and the horizontal members 34. The vertical member 32 is attachable to an attachment point 38 on the tractor 14 for mounting the box scraper 12 to the tractor 14.

A plurality of teeth 38 is provided and each of the teeth 38 is movably disposed in the box scraper 12 to dig into the dirt 17 when the box scraper 12 is drawn along the ground 16. Each of teeth 38 is adjustable between minimum height and a maximum height. Each of the teeth 38 has an upper end 40 and a lower end 42, and each of the teeth 38 extends through a respective one of the slots 28 in the primary member 22. Moreover, the upper end 40 of each of the teeth 38 is spaced upwardly from the top side 24 of the primary member 22 and the lower end 42 of each of the teeth 38 is spaced downwardly from the bottom side 26 of the primary member 22.

An adjustment unit 44 is movably integrated into the box scraper 12 and the adjustment unit 44 is in mechanical communication with each of the teeth 38. The adjustment unit 44 adjusts each of the teeth 38 between the minimum height and the maximum height. Furthermore, the adjustment unit 44 is in communication with a control on the tractor 14 for actuating the adjustment unit 44 to adjust the teeth 38 between the minimum height and the maximum height. The adjustment unit 44 comprises a rod 46 that is rotatably mounted to the box scraper 12. The rod 46 is oriented to extend between the pair of lateral walls 20 of the scraper box and the rod 46 is rotatable about an axis extending between the lateral walls 20.

The adjustment unit 44 includes a first arm 48 has a first end 50 and a second end 52. The first end 50 of the first arm 48 is coupled to the rod 46 and the first arm 48 is centrally positioned between the pair of lateral walls 20 of the scraper box. The adjustment unit 44 includes a hydraulic piston 54 that has a primary end 56 and a secondary end 58. The primary end 56 is coupled to the vertical member 32 of the mounting bracket 30 and the secondary end 58 is coupled to the second end of the first arm 48.

The hydraulic piston 54 is elongated between the primary end 56 and the secondary end 58 when the hydraulic piston 54 is actuated into an extending condition. Conversely, the hydraulic piston 54 is shortened between the primary end 56 and the secondary end 58 when the hydraulic piston 54 is actuated into a retracting condition. The first arm 48 rotates the rod 46 in a first direction when the hydraulic piston 54 is actuated into the extending condition. The first arm 48 rotates the rod 46 in a second direction when the hydraulic piston 54 is actuated into the retracting condition. The hydraulic piston 54 is fluidly coupled to a hydraulic system 60 of the tractor 14 for controlling the hydraulic piston 54.

The adjustment unit 44 includes a plurality of second arms 62 that each has a first end 64 and a second end 66. The first end 64 of each of the second arms 62 is coupled to the rod 46 and each of the second arms 62 is aligned with a respective one of the teeth 38. The second end 66 of each of the second arms 62 is pivotally coupled to the respective tooth 38 at a point that is located adjacent to the upper end 40 of the respective tooth 38. Additionally, each of the second arms 62 is rotated upwardly when the rod 46 is rotated in the first direction such that each of the teeth 38 is lifted. Each of the second arms 62 is rotated downwardly when the rod 46 is rotated in the second direction such that each of the teeth 38 is lowered. Each of the second arms 62 may have a series of bends 68 such that the first end 64 is offset from the second end 66.

In use, the mounting bracket 30 is mounted to the attachment point 38 on the tractor 14 and the hydraulic piston 54 is fluidly coupled to the hydraulic system 60 of the tractor 14. In this way the hydraulic piston 54 can be controlled by a driver of the tractor 14. Thus, the driver can lower or raise the teeth 38 while the driver is operating the tractor 14. In this way the driver can continuously perform dirt 17 excavation work while also adjusting the height of the teeth 38.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A box scraper assembly having adjustable scarification teeth for excavating dirt, said assembly comprising:
a box scraper being attachable to a tractor wherein said box scraper is configured to be drawn across the ground for scraping dirt;
a plurality of teeth, each of said teeth being movably disposed in said box scraper wherein each of said teeth is configured to dig into the dirt when said box scraper is drawn along the ground, each of teeth being adjustable between minimum height and a maximum height; and
an adjustment unit being movably integrated into said box scraper, said adjustment unit being in mechanical communication with each of said teeth, said adjustment unit adjusting each of said teeth between said minimum height and said maximum height, said adjustment unit being in communication with a control on the tractor for actuating said adjustment unit to adjust said teeth between said minimum height and said maximum height.

2. The assembly according to claim 1, wherein:
said box scraper has a rear wall extending between a pair of lateral walls;
said box scraper includes a primary member extending between said pair of lateral walls, said primary member being spaced from said rear wall, said primary member having a top side and a bottom side, said primary member having a plurality of slots each extending through said top side and said bottom side, said slots being spaced apart from each other and being distributed along a full length of said primary member;
said box scraper includes a mounting bracket having a vertical member extending upwardly from said box scraper, said mounting bracket having a plurality of horizontal members being perpendicularly oriented with said vertical member, said mounting bracket having a pair of angled members each angling between said vertical member and said horizontal members, said vertical member being attachable to an attachment point on the tractor.

3. The assembly according to claim 2, wherein each of said teeth has an upper end and a lower end, each of said teeth extending through a respective one of said slots in said primary member such that said upper end of each of said teeth is spaced upwardly from said top side of said primary member and said lower end of each of said teeth is spaced downwardly from said bottom side of said primary member.

4. The assembly according to claim 2, wherein said adjustment unit comprises a rod being rotatably mounted to said box scraper, said rod being oriented to extend between said pair of lateral walls of said scraper box, said rod being rotatable about an axis extending between said lateral walls.

5. The assembly according to claim 4, wherein said adjustment unit includes a first arm having a first end and a second end, said first end of said first arm being coupled to said rod, said first arm being centrally positioned between said pair of lateral walls of said scraper box.

6. The assembly according to claim 5, wherein said adjustment unit includes a hydraulic piston having a primary end and a secondary end, said primary end being coupled to said vertical member of said mounting bracket, said secondary end being coupled to said second end of said first arm, said hydraulic piston being elongated between said primary end and said secondary end when said hydraulic piston is actuated into an extending condition, said hydraulic piston being shortened between said primary end and said secondary end when said hydraulic piston is actuated into a retracting condition, said first arm rotating said rod in a first direction when said hydraulic piston is actuated into said extending condition, said first arm rotating said rod in a second direction when said hydraulic piston is actuated into said retracting condition.

7. The assembly according to claim 6, wherein said adjustment unit includes a plurality of second arms, each of said second arms having a first end and a second end, said first end of each of said second arms being coupled to said rod, each of said second arms being aligned with a respective one of said teeth, said second end of each of said second arms being pivotally coupled to said respective tooth at a point being located adjacent to an upper end of said respective tooth.

8. The assembly according to claim 7, wherein each of said second arms is rotated upwardly when said rod is rotated in said first direction such that each of said teeth is lifted, each of said second arms being rotated downwardly when said rod is rotated in said second direction such that each of said teeth is lowered.

9. A box scraper assembly having adjustable scarification teeth for excavating dirt, said assembly comprising:
a box scraper being attachable to a tractor wherein said box scraper is configured to be drawn across the ground for scraping dirt, said box scraper having a rear wall extending between a pair of lateral walls, said box scraper including a primary member extending between said pair of lateral walls, said primary member being spaced from said rear wall, said primary member having a top side and a bottom side, said primary member having a plurality of slots each extending through said top side and said bottom side, said slots being spaced apart from each other and being distributed along a full length of said primary member, said box scraper including a mounting bracket having a vertical member extending upwardly from said box scraper, said mounting bracket including a plurality of horizontal members being perpendicularly oriented with said vertical member, said mounting bracket including a pair of angled members each angling between said vertical member and said horizontal members, said vertical member being attachable to an attachment point on the tractor;
a plurality of teeth, each of said teeth being movably disposed in said box scraper wherein each of said teeth is configured to dig into the dirt when said box scraper is drawn along the ground, each of teeth being adjustable between minimum height and a maximum height, each of said teeth having an upper end and a lower end, each of said teeth extending through a respective one of said slots in said primary member such that said upper end of each of said teeth is spaced upwardly from said top side of said primary member and said lower end of each of said teeth is spaced downwardly from said bottom side of said primary member; and
an adjustment unit being movably integrated into said box scraper, said adjustment unit being in mechanical communication with each of said teeth, said adjustment unit adjusting each of said teeth between said minimum height and said maximum height, said adjustment unit being in communication with a control on the tractor for actuating said adjustment unit to adjust said teeth between said minimum height and said maximum height, said adjustment unit comprising:
a rod being rotatably mounted to said box scraper, said rod being oriented to extend between said pair of lateral walls of said scraper box, said rod being rotatable about an axis extending between said lateral walls;
a first arm having a first end and a second end, said first end of said first arm being coupled to said rod, said first arm being centrally positioned between said pair of lateral walls of said scraper box;
a hydraulic piston having a primary end and a secondary end, said primary end being coupled to said vertical member of said mounting bracket, said secondary end being coupled to said second end of said first arm, said hydraulic piston being elongated between said primary end and said secondary end when said hydraulic piston is actuated into an extending condition, said hydraulic piston being shortened between said primary end and said secondary end when said hydraulic piston is actuated into a retracting condition, said first arm rotating said rod in a first direction when said hydraulic piston is actuated into said extending condition, said first arm rotating said rod in a second direction when said hydraulic piston is actuated into said retracting condition; and
a plurality of second arms, each of said second arms having a first end and a second end, said first end of each of said second arms being coupled to said rod, each of said second arms being aligned with a respective one of said teeth, said second end of each of said second arms being pivotally coupled to said respective tooth at a point being located adjacent to said upper end of said respective tooth, each of said second arms being rotated upwardly when said rod is rotated in said first direction such that each of said teeth is lifted, each of said second arms being rotated downwardly when said rod is rotated in said second direction such that each of said teeth is lowered.
